(19) United States
(12) Patent Application Publication
(10) Pub. No.: US 2023/0080953 A1
(43) Pub. Date: Mar. 16, 2023

(54) MIXTURE OF NON-REACTIVE THERMOPLASTIC POLYMER AND REACTIVE THERMOPLASTIC POLYMER AND USE THEREOF FOR PREPARING COMPOSITES

(71) Applicant: ARKEMA FRANCE, Colombes (FR)

(72) Inventors: Thibaut SAVART, Lacq (FR); Lise DEVES, Serquigny (FR); Gilles HOCHSTETTER, Colombes Cedex (FR)

(73) Assignee: ARKEMA FRANCE, Colombes (FR)

(21) Appl. No.: 17/798,675

(22) PCT Filed: Feb. 23, 2021
(86) PCT No.: PCT/FR2021/050311

§ 371 Date: Aug. 10, 2022

(30) Foreign Application Priority Data
Feb. 24, 2020 (FR) FR2001818

(51) Int. Cl. C08J 5/24; B29B 15/12; C08L 77/06

(52) U.S. Cl. CPC C08J 5/243; B29B 15/122; C08J 5/249; C08L 77/06; B29K 2101/12

(57) ABSTRACT

The use of a composition including a mixture of at least one non-reactive thermoplastic polymer of Tg >40° C., especially >100° C., in particular >120° C., and at least one reactive thermoplastic prepolymer, with a fibrous material, for the preparation of a fibrous material impregnated with the composition, the composition having an initial melt viscosity during the impregnation, as measured in plate-plate rheology under 1 Hz and 2% strain, at a temperature of 300° C., of less than the viscosity of the same composition devoid of reactive prepolymer, measured under the same conditions, and/or a ductility, after in situ polymerization of the reactive thermoplastic prepolymer in the composition during the impregnation and after the impregnation, that is at least equivalent to the ductility of the same composition devoid of non-reactive thermoplastic polymer, and of which said reactive thermoplastic prepolymer is polymerized to the same number-average molecular mass (Mn).

The present invention relates to a mixture of non-reactive thermoplastic polymer and reactive thermoplastic polymer and to the use thereof with a fibrous material for the preparation of a fibrous material impregnated with said mixture and thus constituting a composite.

The use of thermoplastic polymers for making composites is faced with the difficulty of impregnating the fibrous material due to the high melt viscosity of the thermoplastic polymers, especially when they have a high Tg. If the molar mass of these polymers is reduced too far, they then become fragile and the composites made from these resins exhibit lower performance.

A number of solutions have been considered to circumvent this difficulty. For instance, international application WO 2013/060976 describes the use of a reactive prepolymer or of a reactive mixture composed of a prepolymer that reacts with a chain extender for the impregnation of a fibrous material.

International application WO 2014/064376 describes the use of a non-reactive polymer or a reactive prepolymer or a reactive mixture composed of a prepolymer that reacts with a chain extender or two prepolymers that are reactive with each other, to make composites comprising a high molecular weight thermoplastic polymer matrix, for example for making tapes, or molding composite parts by CRTM. However, the solution described in this second international application either does not allow good and rapid impregnation of the fibers of the fibrous material when using thermoplastic polymers having a high Tg (namely Tg >80° C., preferably >100° C.), since they are very viscous and thus unsuitable for good and rapid impregnation of said fibers, or requires complete polymerization to a high molecular weight in order to achieve good mechanical properties when the impregnation of the fibers is performed on the basis of a reactive mixture based on one or more prepolymers.

U.S. Pat. No. 4,764,397 describes the impregnation of fibrous material with a reactive crosslinkable aromatic polyether prepolymer and a non-reactive polysulfone polymer.

International application 2014/013028 describes a process for impregnating a fibrous material with a mixture of (meth)acrylic monomer and (meth)acrylic polymer.

International application WO 2016/207553 describes the use of prepolymers that are reactive with each other or of a prepolymer comprising two different reactive functions that are reactive with each other for the preparation of composites by pultrusion.

In the case of the solutions developed above based on a single-component reactive prepolymer (i.e. comprising two different reactive functions that are reactive with each other) or of a reactive composition based on a prepolymer and a chain extender or based on two prepolymers, the critical molar mass to be achieved for the final polymer to be ductile will be all the more important since the polymer is very rigid, which is particularly true for high Tg aromatic polymers. In so far as the starting molar mass has to be low to enable high fluidity for use, especially for making composites, the only option for obtaining a ductile polymer and/or a composite having good mechanical properties will be to lengthen the cycle time for manufacturing the composite parts in order to make it possible to achieve a sufficient molar mass during the in situ polymerization, which is counter-productive from an industrial point of view.

In the case of manufacturing a film or web based on polymer fibers, this polymer must have a sufficient melt viscosity to be compatible with the process for manufacturing the film or web. If the desire is to be able to easily and rapidly impregnate dry fibrous materials or reinforcements from hot pressing of this film or this web onto the dry fibrous reinforcement (a process called film stacking), it is advantageous to use a reactive composition for making this film or this web so as to limit its melt viscosity to a value which is sufficient for its use and is not too high to enable good impregnation of the fibers. However, making a film or a web solely composed of a prepolymer risks resulting in a very fragile product which is unsuitable for the required handling at ambient temperature for forming the assembly with the dry fibers before the hot pressing.

There is therefore a need to overcome the drawbacks detailed above.

The present invention thus relates to the use of a composition comprising a mixture of at least one non-reactive thermoplastic polymer of Tg ≥40° C., especially ≥100° C., in particular ≥120° C., and at least one reactive thermoplastic prepolymer, with a fibrous material, for the preparation of a fibrous material impregnated with said composition, said composition having an initial melt viscosity during the impregnation, as measured in plate-plate rheology under 1 Hz and 2% strain, at a temperature of 300° C., of less than the viscosity of the same composition devoid of reactive prepolymer, measured under the same conditions, and/or a ductility, after in situ polymerization of said reactive thermoplastic prepolymer in said composition during the impregnation and after said impregnation, that is at least equivalent to, and in particular greater than, the ductility of the same composition devoid of non-reactive thermoplastic polymer, and of which said reactive thermoplastic prepolymer is polymerized to the same number-average molecular mass (Mn).

The inventors have therefore unexpectedly found that a composition comprising a mixture of at least one non-reactive polymer with at least one reactive polymer made it possible to prepare a fibrous material impregnated with said composition with a good and rapid impregnation and especially with a high Tg non-reactive polymer in the mixture, thus resulting in high-performance composites, i.e. composites having good mechanical properties. Good and rapid impregnation can only be achieved provided that the initial melt viscosity of said composition during the impregnation and after the impregnation of said fibrous material with said composition, measured in plate-plate rheology under 1 Hz and 2% strain, at a temperature of 300° C., is less than the viscosity of the same composition comprising said non-reactive thermoplastic polymer but devoid of reactive prepolymer, and/or provided that the ductility of said composition in which the reactive prepolymer was polymerized in situ during the impregnation and after the impregnation is greater than or equal to the ductility of the same composition devoid of non-reactive thermoplastic polymer and in which said reactive thermoplastic prepolymer is polymerized to the same average molecular mass achieved after impregnation.

In other words, either the composition has an initial melt viscosity during the impregnation and after the impregnation, as measured in plate-plate rheology under 1 Hz and 2% strain, at a temperature of 300° C., which is less than the viscosity of the same composition devoid of reactive prepolymer and measured under the same conditions, or the ductility of said composition in which the reactive prepolymer was polymerized in situ during the impregnation and after the impregnation is greater than or equal to the ductility of the same composition devoid of non-reactive thermoplastic polymer and in which said reactive thermoplastic prepolymer is polymerized to the same average molecular mass, or both the viscosity and the ductility change as described above, so that the impregnation is good and rapid and thus leads to high-performance composites, i.e. composites having good mechanical properties. The expression “initial melt viscosity” means that the number-average molar mass Mn of the prepolymer in the composition during the initiation of the impregnation has not changed by more than a factor of 1.5 to 2 compared to the initial molar mass before impregnation.

The Tg is determined by DMA in accordance with ISO 6721-11:2019.

The number-average (Mn) and weight-average (Mw) molar mass of the polymers was determined by size exclusion chromatography in accordance with ISO standards 16014-1:2012, 16014-2:2012 and 16014-3:2012, using the following conditions:

Apparatus: Waters Alliance 2695 instrument

Solvent: hexafluoroisopropanol stabilized with 0.05 M potassium trifluoroacetate

Flow rate: 1 ml/minute

Column temperature: 40° C.

Two columns in series: 1000 Å PFG and 100 Å PFG (PPS)

Sample concentration: 1 g/l (dissolution at ambient temperature for 24 h)

Filtration of samples using a syringe fitted with an ACRODISC PTFE filter of 25 mm diameter and 0.2 μm porosity

Injection volume: 100 μl

Refractometric detection at 40° C. with UV detection at 228 nm

Calibration by PMMA standards from 1 900 000 to 402 g·mol⁻¹. Calibration curve modeled by a fifth degree polynomial.

The melt viscosity is measured by oscillatory rheology at a temperature of 300° C., on a Physica MCR301 apparatus between two parallel plates with a diameter of 25 mm.

The viscosity is measured over a maximum time of ten minutes.

The expression “non-reactive thermoplastic polymer” means that the thermoplastic polymer has a molecular weight that is no longer likely to change significantly, that is to say that its number-average molecular mass (Mn) changes by less than 20% before it is processed.

It is quite obvious that the non-reactive thermoplastic polymer is capable of reacting in the composition during its processing.

The expression “reactive thermoplastic prepolymer” means that the molecular weight Mn of said reactive prepolymer will change during the subsequent processing of the composition by reaction of reactive prepolymers with each other or reaction of a reactive prepolymer with itself, by condensation with the release of water or by substitution or by reaction of reactive prepolymers with a chain extender by polyaddition without elimination of volatile byproducts to subsequently lead, after use, to a final non-reactive thermoplastic polymer.

This change in the Mn during processing occurs as indicated above to the exclusion of the crosslinking of the reactive thermoplastic prepolymer.

After mixing reactive prepolymer and non-reactive polymer to form the composition and impregnation of the fibrous material with said composition, the latter remains thermoplastic.

The term “ductile” denotes the ability of a material to deform plastically without breaking.

The T_{DB}, as determined in accordance with the standard ISO 179 1eA, is the ductile-brittle transition temperature which corresponds to the temperature at which a material passes from ductile behavior (partial breaking of the material) to brittle behavior (complete fracture of the material). The ductile-brittle transition may therefore be seen as a temperature range where there is 50% brittle fracture (brittle behavior of the sample) and 50% partial fracture (ductile behavior of the sample) and a competition between ductile behavior and brittle behavior.

The Charpy impact test carried out according to the standard ISO 179 1 eA makes it possible to obtain the resilience of the composition.

The ductile-brittle transition (T_{DB}) therefore corresponds to the point of inflection of the curve of resilience as a function of temperature.

Therefore, the T_{DB} of the composition after in situ polymerization of said reactive thermoplastic prepolymer in said composition during impregnation and after impregnation is greater than or equal to the T_{DB} of the same composition devoid of non-reactive thermoplastic polymer, of which said reactive thermoplastic prepolymer is polymerized to the same average molecular mass as after impregnation.

In one embodiment, said ductility after in situ polymerization corresponds to an elongation at break at 23° C. of greater than 10% as measured in accordance with ISO 527-1/2.

### Regarding the Non-Reactive Thermoplastic Polymer and the Reactive Thermoplastic Prepolymer

The non-reactive thermoplastic polymer and the reactive thermoplastic prepolymer constitute a mixture. The mixture may contain at least one non-reactive thermoplastic polymer and at least one reactive thermoplastic prepolymer.

The distinction between the term “polymer” and the term “prepolymer” is made at the level of their respective number-average molecular masses Mn, which are different; namely that the non-reactive thermoplastic polymer has a number-average molecular mass which is from 10 000 to 40 000 g/mol and the reactive thermoplastic prepolymer has a number-average molecular mass which is from 500 to less than 10 000 g/mol and preferably from 2000 to 8000.

Advantageously, the mixture consists of a single non-reactive thermoplastic polymer and a single reactive thermoplastic prepolymer.

Said non-reactive thermoplastic polymer has a Tg ≥40° C., especially ≥100° C., in particular ≥120° C.

In one embodiment, (meth)acrylic polymers are excluded from said non-reactive thermoplastic prepolymer.

In one embodiment, said reactive thermoplastic prepolymer has a Tg <40° C.

In one embodiment, said reactive thermoplastic prepolymer has a Tg ≥40° C., especially ≥100° C., in particular ≥120° C.

In another embodiment, said non-reactive thermoplastic polymer and said reactive thermoplastic prepolymer have a Tg ≥40° C., especially ≥100° C., in particular ≥120° C.

In one embodiment, aromatic polyethers are excluded from said reactive thermoplastic prepolymer.

In one embodiment, (meth)acrylic monomers are excluded from said reactive thermoplastic prepolymer.

In one embodiment, aromatic polyethers are excluded from said reactive thermoplastic prepolymer and (meth)acrylic monomers are excluded from said reactive thermoplastic prepolymer.

In one embodiment, the proportion by weight of non-reactive thermoplastic polymer/reactive thermoplastic prepolymer is from 5/95 to 95/5, especially from 20/80 to 80/20, in particular from 30/70 to 70/30, preferably from 40/60 to 60/40.

The non-reactive thermoplastic polymer and the reactive thermoplastic prepolymer may each be semicrystalline or amorphous.

It is therefore possible to have a mixture of semicrystalline polymer and semicrystalline prepolymer, or a mixture of semicrystalline polymer and amorphous prepolymer, or a mixture of amorphous polymer and semicrystalline prepolymer, or else a mixture of amorphous polymer and amorphous prepolymer.

For the purposes of the invention, a semicrystalline polymer or prepolymer denotes a polymer or prepolymer which has a glass transition temperature determined by dynamic mechanical analysis (DMA) in accordance with the standard ISO 6721-11:2019 and a melting point (Tm) determined in accordance with the standard ISO 11357-3:2013, and an enthalpy of crystallization during the cooling step at a rate of 20 K/min in DSC measured in accordance with the standard ISO 11357-3 of 2013 which is greater than 10 J/g, preferably greater than 30 J/g, and even more preferably of between 30 and 40 J/g.

For the purposes of the invention, an amorphous polymer or prepolymer denotes a polymer or prepolymer which has only a glass transition temperature (no melting point (Tm)).

In a first variant, said mixture consists of a non-reactive thermoplastic polymer which is an amorphous polymer and of a reactive thermoplastic prepolymer which is semicrystalline. In a second variant, said mixture consists of a non-reactive thermoplastic polymer which is a semicrystalline polymer and of a reactive thermoplastic prepolymer which is amorphous.

In one embodiment of the first or second variant, said semicrystalline non-reactive thermoplastic polymer or said semicrystalline reactive thermoplastic prepolymer is chosen from: polybutylene terephthalate (PBT), polyaryletherketones (PAEKs), in particular poly(etheretherketone) (PEEK); polyaryletherketoneketones (PAEKKs), in particular aromatic poly(etherketoneketone) (PEKK); polyaryl sulfides, in particular polyphenylene sulfides (PPSs); polyamides (PAs), in particular semiaromatic polyamides (polyphthalamides) optionally modified with urea units; polyolefins, in particular polyethylene and polypropylene, excluding atactic polypropylene, polylactic acid (PLA), polyvinyl alcohol (PVA), and mixtures thereof, especially a mixture of PEKK and PEI in which PEKK is predominant, preferably from 90-10% by weight to 60-40% by weight, in particular from 90-10% by weight to 70-30% by weight.

Advantageously, said semicrystalline non-reactive thermoplastic polymer or said semicrystalline reactive thermoplastic prepolymer is chosen from: polybutylene terephthalate (PBT), polyaryletherketones (PAEKs), in particular poly(etheretherketone) (PEEK); polyaryletherketoneketones (PAEKKs), in particular aromatic poly(etherketoneketone) (PEKK); polyamides (PAs), in particular semiaromatic polyamides (polyphthalamides) optionally modified with urea units; polyolefins, in particular polyethylene and polypropylene, excluding atactic polypropylene, polylactic acid (PLA), polyvinyl alcohol (PVA), and mixtures thereof, especially a mixture of PEKK and PEI in which PEKK is predominant, preferably from 90-10% by weight to 60-40% by weight, in particular from 90-10% by weight to 70-30% by weight.

In one embodiment of the first or second variant, said amorphous non-reactive thermoplastic polymer or said amorphous reactive thermoplastic prepolymer is chosen from: polyamides, polyetherimides (PEls), polyaryl sulfones, in particular polyphenylene sulfones (PPSUs); polyacrylates, in particular polymethyl methacrylate (PMMA) and polycarbonate (PC).

Advantageously, said amorphous non-reactive thermoplastic polymer or said amorphous reactive thermoplastic prepolymer is chosen from: polyamides, polyetherimides (PEIs), polyaryl sulfones, in particular polyphenylene sulfones (PPSUs); and polycarbonate (PC).

Advantageously, said semicrystalline reactive thermoplastic polymer is chosen from polybutylene terephthalate (PBT) and semiaromatic polyamides.

The nomenclature used to define polyamides is described in the standard ISO 1874-1:2011 “Plastics—Polyamide (PA) molding and extrusion materials—Part 1: Designation”, in particular on page 3 (tables 1 and 2), and is well known to those skilled in the art.

The polyamides are in particular of formula X/YAr, as described in EP 1 505 099, especially a semiaromatic polyamide of formula A/XT in which A is chosen from a moiety obtained from an amino acid, a moiety obtained from a lactam and a moiety corresponding to the formula (Ca diamine).(Cb diacid), with a representing the number of carbon atoms of the diamine and b representing the number of carbon atoms of the diacid, a and b each being between 4 and 36, advantageously between 9 and 18, the (Ca diamine) moiety being chosen from linear or branched aliphatic diamines, cycloaliphatic diamines and alkylaromatic diamines and the (Cb diacid) moiety being chosen from linear or branched aliphatic diacids, cycloaliphatic diacids and aromatic diacids;

X.T denotes a moiety obtained from the polycondensation of a Cx diamine and terephthalic acid, with x representing the number of carbon atoms of the Cx diamine, x being between 6 and 36, advantageously between 9 and 18, especially a polyamide of formula A/6T, A/9T, A/10T or A/11T, A being as defined above, in particular a polyamide chosen from a PA MPMDT/6T, a PA11/10T, a PA 5T/10T, a PA 11/BACT, a PA 11/6T/10T, a PA MXDT/10T, a PA MPMDT/10T, a PA BACT/10T, a PA BACT/6T, PA BACT/10T/6T, a PA 11/BACT/6T, PA 11/MPMDT/6T, PA 11/MPMDT/10T, PA 11/BACT/10T, a PA 11/MXDT/10T, a 11/5T/10T.

T corresponds to terephthalic acid, MXD corresponds to m-xylylenediamine, MPMD corresponds to methylpentamethylenediamine and BAC corresponds to bis(aminomethyl)cyclohexane.

It is quite obvious that when the semiaromatic polyamide A/XT is not semicrystalline over its entire phase diagram, A/XT is chosen in its semicrystalline fraction.

In another embodiment of the first or second variant, said at least one amorphous non-reactive thermoplastic polymer or said amorphous reactive thermoplastic prepolymer is chosen from: polycarbonate and polyamides (PA), in particular cycloaliphatic polyamides or semiaromatic polyamides (polyphthalamides) optionally modified with urea units.

In the same way, it is quite obvious that when the cycloaliphatic or semiaromatic polyamide A/XT is not amorphous over its entire phase diagram, it is chosen in its amorphous fraction.

The cycloaliphatic polyamide is in particular a polyamide of formula XY in which X is at least one cycloaliphatic diamine which may be chosen from bis(3,5-dialkyl-4-aminocyclohexyl)methane, bis(3,5-dialkyl-4-aminocyclohexyl)ethane, bis(3,5-dialkyl-4-aminocyclohexyl)propane, bis(3,5-dialkyl-4-aminocyclohexyl)butane, bis(3-methyl-4-aminocyclohexyl)methane or 3,3′-dimethyl-4,4′-diaminodicyclohexylmethane, commonly called (BMACM) or (MACM) (and denoted B hereinafter), bis(p-aminocyclohexyl)methane, commonly called (PACM) (and denoted P hereinafter), in particular Dicykan®, isopropylidenedi(cyclohexylamine), commonly called (PACP), isophoronediamine (denoted IPD hereinafter) and 2,6-bis(aminomethyl)norbornane, commonly called (BAMN) and bis(aminomethyl)cyclohexane (BAC), in particular 1,3-BAC or in particular 1,4-BAC, advantageously chosen from bis(3-methyl-4-aminocyclohexyl)methane or 3,3′-dimethyl-4,4′-diaminodicyclohexylmethane, commonly called (BMACM) or (MACM) (and denoted B hereinafter), bis(p-aminocyclohexyl)methane, commonly called (PACM) (and denoted P hereinafter) and bis(aminomethyl)cyclohexane (BAC), in particular 1,3-BAC or in particular 1,4-BAC, and

in which Y is at least one C4-C36, preferentially C6-C18, preferentially C6-C12, more preferentially C10-C12, aliphatic dicarboxylic acid, or an aromatic dicarboxylic acid such as isophthalic and terephthalic acid. In yet another embodiment of the first or second variant, said mixture consists of said semicrystalline non-reactive thermoplastic polymer which is chosen from the compounds defined above and

of said amorphous reactive thermoplastic prepolymer which is chosen from the compounds defined above.

In another embodiment, said mixture consists of said amorphous non-reactive thermoplastic polymer which is chosen from the compounds defined above and

of said semicrystalline reactive thermoplastic prepolymer which is chosen from the compounds defined above.

In one embodiment, the number-average molecular mass Mn of said non-reactive thermoplastic polymer is from 10 000 to 40 000, preferably from 14 000 to 25 000 and more preferentially from 15 000 to 21 000 g/mol.

In another embodiment, the number-average molecular mass Mn of said reactive thermoplastic prepolymer is from 500 to less than 10 000, preferably from 2000 to 8000. The average molecular mass of said reactive thermoplastic prepolymer corresponds to the initial average molecular mass, that is to say before impregnation of the fibrous material.

In yet another embodiment, the number-average molecular mass Mn of said non-reactive thermoplastic polymer is from 10 000 to 40 000, preferably from 14 000 to 25 000 and more preferentially from 15 000 to 21 000 g/mol and the number-average molecular mass Mn of said reactive thermoplastic prepolymer is from 500 to less than 10 000, preferably from 2000 to 8000.

Whatever the embodiment of said mixture defined above, the thermoplastic polymer may be of a type different from that of the thermoplastic prepolymer, that is to say for example that the non-reactive polymer may be a polybutylene terephthalate (PBT) and the prepolymer may be a polycarbonate (PC) or vice versa.

The thermoplastic polymer may be of the same type as that of the thermoplastic prepolymer, that is to say for example

that the non-reactive polymer may be an aliphatic polyamide and that the prepolymer may be a semiaromatic polyamide or vice versa or

that the non-reactive polymer may be an aliphatic polyamide and that the prepolymer may be a different aliphatic polyamide or

that the non-reactive polymer may be an aliphatic polyamide and that the reactive prepolymer may be an identical aliphatic polyamide.

Advantageously, the non-reactive thermoplastic polymer is of the same type as that of the reactive thermoplastic prepolymer, in particular the non-reactive thermoplastic polymer is a semiaromatic polyamide and the reactive prepolymer is a semiaromatic or aliphatic polyamide, in particular the non-reactive thermoplastic polymer and the reactive thermoplastic prepolymer are both semiaromatic.

### Regarding the Composition

Said composition comprises a mixture of at least one non-reactive thermoplastic polymer and at least one thermoplastic prepolymer.

In one embodiment, said composition comprises:

33% to 100% by weight of a mixture of at least one non-reactive thermoplastic polymer and at least one reactive thermoplastic prepolymer,

0% to 20% by weight of at least one impact modifier, in particular 1% to 20% by weight of at least one impact modifier,

0% to 20% by weight of at least one plasticizer, in particular 1% to 20% by weight of at least one plasticizer,

0% to 25% by weight of at least one flame retardant, in particular 1% to 20% by weight of at least one flame retardant,

0% to 2% by weight of at least one additive, in particular 0.1% to 2% by weight of at least one additive,

the sum of the various constituents being equal to 100%.

Advantageously, said mixture consists of a single non-reactive thermoplastic polymer and a single reactive thermoplastic prepolymer.

In one embodiment, said composition consists of:

33% to 100% by weight of a mixture of at least one non-reactive thermoplastic polymer and at least one reactive thermoplastic prepolymer,

0% to 20% by weight of at least one impact modifier, in particular 1% to 20% by weight of at least one impact modifier,

0% to 20% by weight of at least one plasticizer, in particular 1% to 20% by weight of at least one plasticizer,

0% to 25% by weight of at least one flame retardant, in particular 1% to 20% by weight of at least one flame retardant,

0% to 2% by weight of at least one additive, in particular 0.1% to 2% by weight of at least one additive,

the sum of the various constituents being equal to 100%.

Advantageously, said mixture consists of a single non-reactive thermoplastic polymer and a single reactive thermoplastic prepolymer.

### The Impact Modifier

Impact modifiers are well known to those skilled in the art and the impact modifier advantageously consists of a polymer having a flexural modulus of lower than 100 MPa measured in accordance with the standard ISO 178 and a Tg of less than 0° C. (measured in accordance with the standard 11357-2:2013 at the inflection point of the DSC thermogram), in particular a polyolefin.

In one embodiment, PEBAs are excluded from the definition of impact modifiers.

The polyolefin of the impact modifier may be functionalized or nonfunctionalized or be a mixture of at least one which is functionalized and/or at least one which is nonfunctionalized.

### The Flame Retardant

Said flame retardants may be halogen-free flame retardants, as described in US 2008/0274355, and especially a metal salt chosen from a metal salt of phosphinic acid, a metal salt of diphosphinic acid, a polymer containing at least one metal salt of phosphinic acid, a polymer containing at least one metal salt of diphosphinic acid, or red phosphorus, an antimony oxide, a zinc oxide, an iron oxide, a magnesium oxide or metal borates such as a zinc borate or else melamine pyrophosphates and melamine cyanurates. They may also be halogenated flame retardants such as a brominated or polybrominated polystyrene, a brominated polycarbonate or a brominated phenol.

### The Additives

Said composition may also comprise additives.

The additives may be chosen from an antioxidant, a heat stabilizer, a UV absorber, a light stabilizer, a lubricant, an inorganic filler, a nucleating agent, a plasticizer, a colorant, carbon-based fillers, in particular carbon black and carbon-based nanofillers.

In one embodiment, said composition additionally comprises carbon-based fillers, in particular carbon black, or carbon-based nanofillers, preferably chosen from graphenes, carbon nanotubes, carbon nanofibrils, or mixtures thereof.

### Regarding the Fibrous Material

Regarding the fibers constituting said fibrous material, these are especially fibers of mineral, organic or plant origin.

Advantageously, said fibrous material may be sized or nonsized.

Said fibrous material may therefore comprise up to 0.1% by weight of a material of organic nature (thermosetting or thermoplastic resin type), called size.

Among the fibers of mineral origin, mention may be made of carbon fibers, glass fibers, basalt or basalt-based fibers, silica fibers or silicon carbide fibers, for example. Among the fibers of organic origin, mention may be made of fibers based on a thermoplastic or thermosetting polymer, such as semiaromatic polyamide fibers, aramid fibers or polyolefin fibers for example. Preferably, they are based on an amorphous thermoplastic polymer and have a glass transition temperature Tg above the Tg of the thermoplastic polymer or polymer mixture constituting the pre-impregnation matrix when the latter is amorphous, or above the Tm of the thermoplastic polymer or polymer mixture constituting the pre-impregnation matrix when the latter is semicrystalline. Advantageously, they are based on a semicrystalline thermoplastic polymer and have a melting temperature Tm above the Tg of the thermoplastic polymer or polymer mixture constituting the pre-impregnation matrix when the latter is amorphous, or above the Tm of the thermoplastic polymer or polymer mixture constituting the pre-impregnation matrix when the latter is semicrystalline. Thus, there is no risk of melting for the organic fibers constituting the fibrous material during impregnation by the thermoplastic matrix of the final composite. Among the fibers of plant origin, mention may be made of natural fibers based on flax, hemp, lignin, bamboo, silk especially spider silk, sisal, and other cellulose fibers, in particular viscose fibers. These fibers of plant origin can be used pure, treated or else coated with a coating layer, for the purpose of facilitating the adhesion and impregnation of the thermoplastic polymer matrix.

The fibrous material may also be a fabric, braided or woven with fibers.

It may also correspond to fibers with support yarns.

These constituent fibers can be used alone or as mixtures. Thus, organic fibers can be mixed with mineral fibers in order to be pre-impregnated with thermoplastic polymer powder and form the pre-impregnated fibrous material.

The rovings of organic fibers may have several basis weights. In addition, they can exhibit several geometries. The constituent fibers of the fibrous material may also be in the form of a mixture of these reinforcing fibers of various geometries. The fibers are continuous fibers. Preferably the fibrous material is formed by continuous fibers of carbon or of glass, or a mixture thereof, in particular carbon fibers. It is used in the form of a roving or several rovings.

Advantageously, the number of fibers in said fibrous material for carbon fibers is greater than or equal to 3K, in particular greater than or equal to 6K, especially greater than or equal to 12K, in particular chosen from 12K, 24K, 48K, 50K and 400K, especially 12K, 24K, 48K and 50K, or the basis weight for the glass fiber is greater than or equal to 1200 tex, especially greater than or equal to 2400 tex, or greater than or equal to 4800 tex.

### Regarding the Pre-Impregnated Fibrous Material and Impregnated Fibrous Material

According to another aspect, the present invention relates to a fibrous material impregnated with a composition comprising a mixture as defined above.

According to yet another aspect, the present invention relates to a fibrous material pre-impregnated with a composition comprising a mixture as defined above.

As indicated below in the various embodiments of the process for preparing said impregnated fibrous material, the latter may be obtained by impregnating said fibrous material with said composition comprising said mixture defined above, by the molten route, or with a prior step of pre-impregnating said fibrous material with said composition comprising said mixture defined above, in powder form.

It is therefore necessary to distinguish between two types of fibrous materials:

A fibrous material pre-impregnated before polymerization of said reactive prepolymer, said fibrous material being pre-impregnated with said composition comprising said mixture in powder form, and a fibrous material impregnated with said composition comprising said mixture, by the molten route, and therefore after polymerization of said reactive prepolymer. Said impregnated fibrous material then comprises a mixture of non-reactive thermoplastic polymer, of reactive thermoplastic prepolymer which has polymerized with itself, and also a non-reactive thermoplastic polymer which has polymerized with one or more reactive prepolymers.

The Mn of the prepolymer having polymerized with itself is then greater by at least 20% compared to the initial Mn of the prepolymer before any polymerization, in particular by at least 50%, especially by at least 100%, more particularly by at least 200%.

Said impregnated or pre-impregnated fibrous material has a number of fibers in said fibrous material for carbon fibers of greater than or equal to 3K, in particular greater than or equal to 6K, especially greater than or equal to 12K, in particular chosen from 12K, 24K, 48K, 50K and 400K, especially 12K, 24K, 48K and 50K, or a basis weight for the glass fiber of greater than or equal to 1200 tex, especially greater than or equal to 2400 tex, or greater than or equal to 4800 tex.

Advantageously, said impregnated fibrous material has a content of fibers by volume which is constant in at least 70% of the volume of the impregnated fibrous material, especially in at least 80% of the volume of the impregnated fibrous material, in particular in at least 90% of the volume of the impregnated fibrous material, more particularly in at least 95% of the volume of the impregnated fibrous material.

More advantageously, said impregnated fibrous material has a degree of porosity of less than 10%, especially less than 5%, in particular less than 2%.

In one embodiment, said impregnated fibrous material is a monolayer impregnated fibrous material.

In another embodiment, said impregnated fibrous material is non-flexible.

In yet another embodiment, said impregnated fibrous material is a non-flexible monolayer impregnated fibrous material.

The term “monolayer” means that when the impregnation of the fibrous material is carried out, the impregnation being carried out in a particularly homogeneous manner and to the core, and in particular with at least one spreading during the impregnation, said fibrous material and the polymer are inseparable from one another and form a material consisting of a single layer based on fibers and on polymer mixture.

In other words, the term “monolayer” means that the content of fibers by volume and the distribution of the fibers is substantially identical on average on either side of the median plane of the fibrous material over the entire length of said fibrous material.

The term “substantially” means that the content of fibers by volume and the fiber distribution is at least 70% identical on average on either side of the median plane of the fibrous material over the entire length of said fibrous material, especially at least 80%, in particular at least 90% and more particularly at least 95%.

### Regarding the Process

According to another aspect, the present invention relates to a process for preparing an impregnated fibrous material as defined above, or a pre-impregnated fibrous material as defined above, characterized in that it comprises a step of pre-impregnating or a step of impregnating said fibrous material with a composition comprising a mixture as defined above. In a first variant of the process, said impregnation step is carried out by the molten route, especially at high speed, in particular at a speed of at least 0.3 to 10 m/min for the molten route, in particular of at least 2 m/min.

Advantageously, said process comprises the following steps:

i) impregnating a fibrous material with a composition comprising said mixture by the molten route, especially by pultrusion, by crosshead extrusion of molten polymer, to obtain an impregnated fibrous material,

ii) optionally a step of shaping and calibrating said impregnated fibrous material to obtain an impregnated fibrous material consisting of a ribbon in the form of a thin strip with a thickness of from 0.05 to 5 mm and preferably 0.15 to 1.3 mm thick.

In one embodiment, at least one spreading during the impregnation is carried out especially at the level of at least one tension device upstream or in the impregnation system.

In a second variant of the process, the fibers are heated by means of an oven, preferably by IR, upstream of the impregnation system.

In a third variant of the process, said process comprises a step of pre-impregnating said fibrous material with a composition comprising said mixture in powder form.

Advantageously, said pre-impregnation is carried out with a system chosen from a fluidized bed, gun spraying, continuous passage of the fibers through an aqueous dispersion of powder of said non-reactive thermoplastic polymer or aqueous dispersion of particles of said thermoplastic polymer or aqueous emulsion or suspension of said non-reactive thermoplastic polymer, especially at high speed.

This pre-impregnation process can be carried out as described in WO 2018/115736 for the fluidized bed, in WO 2018/115737 for the aqueous dispersion and in WO 2018/115739.

In one embodiment, at least one spreading during the pre-impregnation is carried out especially at the level of at least one tension device (E′) upstream or in the impregnation system.

The impregnation step may thus be carried out in particular by crosshead extrusion of the polymer matrix and passage of said roving or said rovings through this crosshead and then passage through a heated die, the crosshead being provided with fixed or rotating tension devices (E′) over which the roving runs, thus causing spreading of said fibrous material (also called “roving”), enabling pre-impregnation of said roving.

A tension device (E′) is understood to mean any system on which the roving has the possibility of running through the tank. The tension device (E′) may have any shape as long as the roving can run on it.

Advantageously, it is cylindrical.

In one embodiment of this second variant, said process comprises at least one step of tensioning-free heating of said pre-impregnated fibrous material.

In another embodiment of this second variant, said process comprises at least one step of heating carried out by means of at least one tension device (E) and at least one heating system, said roving or said rovings being in contact with part or all of the surface of said at least one tension device (E) and running partially or completely over the surface of said at least one tension device (E) close to, at or after the heating system.

Said process of this other embodiment of this second variant may be carried out as described in WO 2018/234439 or WO 2018/234434 except for certain locations of the tension device with respect to the heating system.

Indeed, the tension device(s) (E) are either in the environment of the heating system, that is to say they are not outside the heating system, or they are all located or included after the heating system and therefore outside of the latter at a distance of from 1 cm to 100 cm.

In the latter case, said polymer having pre-impregnated the fibrous material is then at a temperature of greater than or equal to its Tg.

In the case where a plurality of tension devices are used, the tension devices are 5 to 15 cm apart.

It is quite obvious that it would not constitute a departure from the scope of the invention if one or more tension devices (E) were located close to and at and after the heating system, or else close to and at the heating system or else close to and after the heating system or else at and after the heating system.

The tension device (E) is as described for (E′). Nevertheless, (E) and (E′) may be identical or different.

A spreading of the fibrous material takes place during its partial or total running on said tension device(s) (E).

It is preceded, during the passage of the roving through the heating system, before the partial or total running thereof on said tension device(s) (E), by a retraction of the roving due to the melting of the polymer on said roving.

This spreading combined with the melting of said composition comprising said mixture by the heating system and combined with the retraction of the roving make it possible to make the pre-impregnation uniform and finalize the impregnation and to thus have a core impregnation and to have a high content of fibers by volume, in particular constant in at least 70% of the volume of the fibrous material, especially in at least 80% of the volume of the fibrous material, in particular in at least 90% of the volume of the fibrous material, more particularly in at least 95% of the volume of the fibrous material, and also to decrease the porosity.

Advantageously, the percentage of spreading during the heating step is from approximately 0% to 300%, in particular 0% to 50%.

The various instances of spreading during the heating step combined with the melting of the thermoplastic polymer and the retraction of the roving during said heating step make it possible to obtain a content of fibers impregnated after the heating step of from 45% to 64% by volume, preferably from 50% to 60% by volume, in particular from 54% to 60% by volume, the content of fibers by volume and the distribution of the fibers being substantially identical on average on either side of the median plane of the fibrous material over the entire length of said fibrous material, thus resulting in the obtaining of an, in particular monolayer, fibrous material.

Below 45% of fibers, the reinforcement is insignificant as regards the mechanical properties.

Above 65%, the limits of the process are reached and the mechanical properties are lost again.

Advantageously, the heating system is chosen from an infrared lamp, a UV lamp, convection heating, microwave heating, laser heating and high-frequency (HF) heating.

In one embodiment, said process defined above comprises the following steps:

i) pre-impregnating a fibrous material with a composition comprising said mixture by fluidized bed in a tank which may or may not be equipped with a tension device (E′), by nozzle or gun spraying by the dry route in a tank which may or may not be equipped with at least one tension device (E′), to obtain a pre-impregnated fibrous material,

ii) a step of tensioning-free heating of said pre-impregnated fibrous material to obtain a fibrous material pre-impregnated with said mixture of molten polymer(s) and prepolymer(s),

iii) a step of heating carried out by means of at least one tension device (E) and at least one heating system, as defined in claim 23 or 24, to obtain an impregnated fibrous material,

iv) optionally a step of shaping and calibrating the roving or said parallel rovings of said impregnated fibrous material to obtain an impregnated fibrous material consisting of a ribbon in the form of a thin strip.

In another embodiment, said process defined above comprises the following steps:

i) pre-impregnating a fibrous material with a composition comprising said mixture by continuous passage of the fibers through a fluidized bed of dry polymer powder, an aqueous dispersion of polymer powder or aqueous dispersion of polymer particles or aqueous emulsion or suspension of polymer,

ii) a step of tensioning-free heating of said pre-impregnated fibrous material to obtain a fibrous material impregnated with said mixture of molten polymer(s) and prepolymer(s),

iii) optionally a step of heating carried out by means of at least one tension device (E) and at least one heating system to obtain an impregnated fibrous material,

iv) optionally a step of shaping and calibrating the roving or said parallel rovings of said impregnated fibrous material to obtain a fibrous material impregnated with said mixture of polymer(s) and partially or completely polymerized prepolymer(s), consisting of a ribbon in the form of a thin strip.

In one embodiment, one or more tension device(s) (E″) is/are present upstream of the impregnation or pre-impregnation step of said process defined above.

In another embodiment, said process defined above is carried out for the dry powder route at a speed of between 5 and 30 m/min and for the aqueous dispersion at a speed of at least 5 m/min.

According to another aspect, the present invention relates to the use of an impregnated fibrous material, as defined above, for the preparation of ribbons suitable for the manufacture of three-dimensional composite parts, by automated layup of said ribbons using a robot.

According to yet another aspect, the present invention relates to the use of an impregnated fibrous material, as defined above, for the preparation of thermoformable sheets.

Advantageously, the impregnated fibrous material is precut into pieces, said pieces being randomly associated or oriented for the preparation of the thermoformable sheet.

### EXAMPLES

### Example 1: Synthesis of BACT/10T

The following procedure is an example of a preparation process, and is not limiting. It is representative of all the compositions according to the invention:

5 kg of the following starting materials are introduced into a 14-liter autoclave reactor:

500 g of water,

the diamines,

the amino acid (optionally),

the terephthalic acid and optionally one or more other diacids,

35 g of sodium hypophosphite in solution,

0.1 g of a Wacker AK1000 antifoaming agent (Wacker Silicones).

The closed reactor is purged of its residual oxygen and then heated to a temperature of 280° C. of the material. After stirring for 30 minutes under these conditions, the pressurized vapor which has formed in the reactor is gradually reduced in pressure over 60 minutes, while gradually increasing the material temperature so that it becomes established at Tm+10° C. at atmospheric pressure.

To obtain the prepolymer, the pressure reduction has to be stopped at approximately 15 bar or have greatly limited the polymer to stop its growth.

The polymer or oligomer (prepolymer) is subsequently emptied out via the bottom valve, then cooled in a water trough and then ground.

### Example 2: Impregnation of a Fibrous Material (Carbon Fiber) With a Powder of Non-Reactive Polymer or of Reactive Prepolymer or of a Mixture of the Two

The fibrous material (¼″ Toray, 12K T700S 31E carbon fiber) was pre-impregnated in a fluidized bed and then impregnated by heating as described in WO2018/234439 with a powder:

of a non-reactive polymer (Rilsan® Clear G850 Rnew® (Arkema) of Tg=150° C. and solution viscosity of 1.2 (measured in m-cresol, at 20° C., in accordance with ISO 307:2019, using a Schott type 538-23 IIC micro-Ubbelohde tube) corresponding to an Mn of 20 000 g/mol or BACT/10T (51.9/48.1 by weight) of Mn=20 000 g/mol and Tg=160° C. or Xenoy™ (PC/PBT SABIC) (1103 or HX5600HP)); or

of a reactive prepolymer BACT/10T (51.9/48.1 by weight) of Mn=6300 g/mol and Tg=160° C.; or

of a 60/40 mixture of non-reactive polymer (Rilsan® Clear G850 Rnew® (Arkema) of Tg=150° C. and solution viscosity of 1.2 (measured in m-cresol, at 20° C., in accordance with ISO 307:2019, using a Schott type 538-23 IIC micro-Ubbelohde tube) corresponding to an Mn of 20 000 g/mol and of reactive prepolymer BACT/10T (51.9/48.1 by weight) of Mn=6300 g/mol and Tg=160° C.

### Example 3: Comparison of the Viscosity and Ductility of Various Compositions of Amorphous or Semicrystalline Polymer and Prepolymer and the Mixture Thereof

The viscosity is measured in plate-plate rheology under 1 Hz and 2% strain, at a temperature of 300° C., and the ductility is determined by the elongation at break at a temperature of 23° C. as measured in accordance with ISO 527-1/2:2012.

An INSTRON® 5966 type machine is used. The crosshead speed is 5 mm/min. The test conditions are 23° C., dry, with the samples of ISO 527 1A geometry having been conditioned beforehand for 2 weeks at 23° C., 50% RH. The strain is measured by a contact extensometer.

The results are shown in table 1.

TABLE 1

| POLYMER OR | VISCOSITY | |
|---|---|---|
| PREPOLYMER OR | at 300° C. | DUCTILE/ |
| MIXTURE OF THE TWO | (Pa · s) | BRITTLE |
| C1 | 250 | DUCTILE |
| AMORPHOUS POLYMER | | Elongation at |
| Rilsan ® Clear G850 Rnew ® | | break >50% |
| (Arkema) Mn = 20 000 g/mol | | |
| C2 | 5000 | BRITTLE |
| SEMICRYSTALLINE | | Elongation at |
| POLYMER BACT/10T | | break 3% |
| (51.9/48.1) Mn = 20 000 g/mol | | |
| C3 | 70 | DUCTILE |
| SEMICRYSTALLINE | | Elongation at |
| POLYMER Xenoy ™ | | break >=100% |
| (SABIC) (1103 or HX5600HP) | | |
| MIXTURE OF PC AND PBT | | |
| I1 | 150 before | DUCTILE after |
| 60% by weight of | polymerization | polymerization |
| AMORPHOUS POLYMER | of the | of the BACT/10T |
| Rilsan ® Clear G850 Rnew ® | BACT/10T | Elongation at |
| (Arkema) Mn = 20 000 g/mol + | | break >50% |
| 40% by weight of | | |
| SEMICRYSTALLINE | | |
| PREPOLYMER BACT/10T | | |
| (51.9/48.1) Mn = 6300 g/mol | | |
| I2 | 100 before | DUCTILE after |
| 20% by weight of | polymerization | polymerization |
| AMORPHOUS POLYMER | of the | of the BACT/10T |
| Rilsan ® Clear G850 Rnew ® | BACT/10T | Elongation at |
| (Arkema) Mn = 20 000 g/mol + | | break 20% |
| 80% by weight of | | |
| SEMICRYSTALLINE | | |
| PREPOLYMER BACT/10T | | |
| (51.9/48.1) Mn = 6300 g/mol | | |
| I3 | 10 | DUCTILE after |
| 40% by weight of | | polymerization |
| AMORPHOUS POLYMER | | of the PBT |
| PC + 60% by weight of | | Elongation at |
| SEMICRYSTALLINE | | break >10% |
| PREPOLYMER PBT | | |

C1 to C3: comparative compositions
I1 to I3: compositions according to the invention

### Results

I1: the 60/40 by weight mixture of amorphous non-reactive polymer G850 and of semicrystalline reactive prepolymer BACT/10T (mass 6300 g/mol) is more fluid before in situ polymerization of the BACT/10T prepolymer than the pure G850 and the mixture is ductile after in situ polymerization just as the pure G850 was.

I2: the 20/80 by weight mixture of amorphous non-reactive polymer G850 and of semicrystalline reactive prepolymer BACT/10T (mass 6300 g/mol) is more fluid (100 Pa·s) before in situ polymerization of the BACT/10T prepolymer than the pure G850 and is more ductile than the pure BACT/10T (Mn 20 000 g/mol) after in situ polymerization of the BACT/10T prepolymer up to 15 000 g/mol.

I3: the 40/60 by weight mixture of amorphous PC polymer and of PBT prepolymer (prepolymer mass 5000 g/mol) is more fluid before polymerization than the commercial PC/PBT mixture, and after polymerization of the PBT the mixture is ductile like the commercial product and has a Tm of 220° C., which is comparable to the commercial product.

### Example 4: Determination of the Degree of Porosity by Image Analysis

The porosity was determined by image analysis of a 1/4″ carbon fiber roving impregnated with MPMDT/10T in fluidized bed with upstream tension devices followed by a heating step as defined above.

It is less than 5%.

### Example 5: Determination of the Degree of Porosity—the Relative Deviation Between Theoretical Density and Experimental Density (General Method)

a) The data required are:
The density of the thermoplastic matrix
The density of the fibers
The basis weight of the reinforcement:
   linear density (g/m) for example for a′ inch tape (derived from a single roving) surface density (g/m²) for example for a wider tape or a woven fabric

b) Measurements to be performed:

The number of samples must be at least 30 so that the result is representative of the material studied.

The measurements to be performed are:
The size of the samples taken:
   Length (if linear density is known).
   Length and width (if surface density is known).
The experimental density of the samples taken:
   Measurements of mass in air and in water.
Measurement of the content of fibers is determined in accordance with ISO 1172:1999 or by thermogravimetric analysis (TGA) as determined for example in document B. Benzler, Applikationslabor, Mettler Toledo, Giesen, UserCom 1/2001.

The measurement of the content of carbon fibers may be determined according to ISO 14127:2008.

Determination of the theoretical weight content of fibers:

a) Determination of the theoretical weight content of fibers:

$$\% {Mf}_{th} = \frac{{m}_{l} . L}{{Me}_{air}} \qquad [ Math 1 ]$$

with

mₗthe linear density of the tape,

L the length of the sample and

Meₐᵢᵣ the mass of the sample measured in air.

The variation in the weight content of fibers is assumed to be directly linked to a variation in the content of matrix without taking into account the variation in the amount of fibers in the reinforcement.

b) Determination of the theoretical density:

$${d}_{th} = \frac{1}{\frac{1 - \% {Mf}_{th}}{{d}_{m}} + \frac{\% {Mf}_{th}}{{d}_{f}}} \qquad [ Math 2 ]$$

with dₘ and d_{f} the respective densities of the matrix and of the fibers.

The theoretical density thus calculated is the accessible density if there is no porosity in the samples.

c) Evaluation of the porosity:

The porosity is then the relative deviation between the theoretical density and the experimental density.

1. The use of a composition with a fibrous material for the preparation of a fibrous material impregnated with said composition, said composition comprising a mixture of at least one non-reactive thermoplastic polymer of Tg ≥40° C., and at least one reactive thermoplastic prepolymer, the proportion by weight of non-reactive thermoplastic polymer/reactive thermoplastic prepolymer being from 5/95 to 95/5,
the non-reactive thermoplastic polymer being an amorphous polymer and the reactive thermoplastic prepolymer being a semicrystalline polymer, or the non-reactive thermoplastic polymer being a semicrystalline polymer and the reactive thermoplastic prepolymer being an amorphous polymer,
said amorphous non-reactive thermoplastic polymer or said amorphous reactive thermoplastic prepolymer being chosen from: polyamides, polyetherimides (PEIs), polyaryl sulfones, and polycarbonate (PC), and
said semicrystalline non-reactive thermoplastic polymer or said semicrystalline reactive thermoplastic prepolymer being chosen from: polybutylene terephthalate (PBT), polyaryletherketones (PAEKs); polyaryletherketoneketones (PAEKKs); polyamides (PAs); polyolefins, excluding atactic polypropylene, polylactic acid (PLA), polyvinyl alcohol (PVA), and mixtures thereof,
for the preparation of a fibrous material impregnated with said composition, said composition having an initial melt viscosity during the impregnation, as measured in plate-plate rheology under 1 Hz and 2% strain, at a temperature of 300° C., of less than the viscosity of the same composition devoid of reactive prepolymer, measured under the same conditions, and/or a ductility, after in situ polymerization of said reactive thermoplastic prepolymer in said composition during the impregnation and after the impregnation, that is at least equivalent to the ductility of the same composition devoid of non-reactive thermoplastic polymer, and of which said reactive thermoplastic prepolymer is polymerized to the same number-average molecular mass (Mn).

2. The use as claimed in claim 1, wherein the proportion by weight of non-reactive thermoplastic polymer/reactive thermoplastic prepolymer is from 5/95 to 95/5.

3. The use as claimed in claim 1, wherein said semicrystalline reactive thermoplastic polymer is chosen from polybutylene terephthalate (PBT) and semiaromatic polyamides.

4. The use as claimed in claim 1, wherein said amorphous non-reactive thermoplastic polymer or said amorphous reactive thermoplastic prepolymer is chosen from: polycarbonate and polyamides (PA).

5. The use as claimed in claim 1, wherein the number-average molecular mass Mn of said non-reactive thermoplastic polymer is from 10,000 to 40,000.

6. The use as claimed in claim 1, wherein the number-average molecular mass Mn of said reactive thermoplastic prepolymer is from 500 to less than 10,000.

7. A fibrous material impregnated with a composition comprising a mixture as defined in claim 1.

8. The impregnated fibrous material as claimed in claim 7, wherein the number of fibers in said fibrous material for carbon fibers is greater than or equal to 3K, or the basis weight for the glass fiber is greater than or equal to 1200 tex.

9. The impregnated fibrous material as claimed in claim 7, wherein the content of fibers by volume is constant in at least 70% of the volume of the impregnated fibrous material.

10. The impregnated fibrous material as claimed in claim 7, wherein the degree of porosity in said impregnated fibrous material is less than 10%.

11. The impregnated fibrous material as claimed in claim 7, wherein said impregnated fibrous material is a monolayer impregnated fibrous material.

12. The impregnated fibrous material as claimed in claim 7, wherein said impregnated fibrous material is non-flexible.

13. A fibrous material pre-impregnated with a composition comprising a mixture as defined in claim 1.

14. A process for preparing an impregnated fibrous material as defined in claim 7, wherein the process comprises a step of pre-impregnating or a step of impregnating said fibrous material with the composition comprising the mixture.

15. The process as claimed in claim 14, wherein said impregnation step is carried out by the molten route.

16. The process as claimed in claim 14, wherein it comprises the following steps:
i) impregnating a fibrous material with a composition comprising said mixture by the molten route to obtain an impregnated fibrous material,
ii) optionally a step of shaping and calibrating said impregnated fibrous material to obtain an impregnated fibrous material consisting of a ribbon in the form of a thin strip with a thickness of from 0.05 to 5 mm.

17. The process for preparing an impregnated fibrous material or a pre-impregnated fibrous material as claimed in claim 14, wherein it comprises a step of pre-impregnating said fibrous material with a composition comprising said mixture in powder form.

18. The process as claimed in claim 17, wherein said pre-impregnation is carried out with a system chosen from a fluidized bed, gun spraying, continuous passage of the fibers through an aqueous dispersion of powder of said non-reactive thermoplastic polymer or aqueous dispersion of particles of said thermoplastic polymer or aqueous emulsion or suspension of said non-reactive thermoplastic polymer.

19. The process as claimed in claim 17, wherein it comprises at least one step of tensioning-free heating of said pre-impregnated fibrous material.

20. The process as claimed in claim 17, wherein it comprises at least one step of heating carried out by means of at least one tension device (E) and at least one heating system, said roving or said rovings being in contact with part or all of the surface of said at least one tension device (E) and running partially or completely over the surface of said at least one tension device (E) close to, at or after the heating system.

21. Process as claimed in claim 19, wherein the heating system is chosen from an infrared lamp, a UV lamp, convection heating, microwave heating, laser heating and high-frequency (HF) heating.

22. The process as claimed in claim 17, wherein it comprises the following steps:
i) pre-impregnating a fibrous material with a composition comprising said mixture by fluidized bed in a tank which may or may not be equipped with a tension device (E′), by nozzle or gun spraying by the dry route in a tank which may or may not be equipped with at least one tension device (E′), to obtain a pre-impregnated fibrous material,
ii) a step of tensioning-free heating of said pre-impregnated fibrous material to obtain a fibrous material pre-impregnated with said mixture of molten polymer(s) and prepolymer(s),
iii) a step of heating carried out by means of at least one tension device (E) and at least one heating system to obtain an impregnated fibrous material,
iv) optionally a step of shaping and calibrating the roving or said parallel rovings of said impregnated fibrous material to obtain an impregnated fibrous material consisting of a ribbon in the form of a thin strip.

23. The process as claimed in claim 17, wherein it comprises the following steps:
i) pre-impregnating a fibrous material with a composition comprising said mixture by continuous passage of the fibers through a fluidized bed of dry polymer powder, an aqueous dispersion of polymer powder or aqueous dispersion of polymer particles or aqueous emulsion or suspension of polymer,
ii) a step of tensioning-free heating of said pre-impregnated fibrous material to obtain a fibrous material impregnated with said mixture of molten polymer(s) and prepolymer(s),
iii) optionally a step of heating carried out by means of at least one tension device (E) and at least one heating system to obtain an impregnated fibrous material,
iv) optionally a step of shaping and calibrating the roving or said parallel rovings of said impregnated fibrous material to obtain a fibrous material impregnated with said mixture of polymer(s) and partially or completely polymerized prepolymer(s), consisting of a ribbon in the form of a thin strip.

24. The process as claimed in claim 14, wherein one or more tension device(s) (E″) is/are present upstream of the impregnation or pre-impregnation step.

25. The process as claimed in claim 17, wherein it is carried out for the dry powder route at a speed of between 5 and 30 m/min and for the aqueous dispersion at a speed of at least 5 m/min.

26. The use of an impregnated fibrous material, as defined in claim 7, for the preparation of ribbons suitable for the manufacture of three-dimensional composite parts, by automated layup of said ribbons using a robot.

27. The use of an impregnated fibrous material, as defined in claim 7, for the preparation of thermoformable sheets.

28. The use as claimed in claim 27, wherein the impregnated fibrous material is precut into pieces, said pieces being randomly associated or oriented for the preparation of the thermoformable sheet.
